(19) United States
(12) Patent Application Publication
(10) Pub. No.: US 2016/0167810 A1
(43) Pub. Date: Jun. 16, 2016

(54) Adjustment Mechanism for Adjusting at Least One Engine of a Spacecraft

(71) Applicant: RUAG Space GmbH, Vienna (AT)

(72) Inventors: Paul JANU, Vienna (AT); Christian NEUGEBAUER, Vienna (AT)

(21) Appl. No.: 14/971,327

(22) Filed: Dec. 16, 2015

(30) Foreign Application Priority Data
Dec. 16, 2014 (AT) A 913/2014

(51) Int. Cl. B64G 1/24; B64G 1/40

(52) U.S. Cl. CPC B64G 1/24; B64G 1/40

(57) ABSTRACT

In an adjustment mechanism for adjusting at least one engine of a spacecraft, including an engine plate for the at least one engine, a pivotable boom for pivoting the engine plate between a retracted position adjacent the spacecraft and at least one extracted position spaced apart from the spacecraft, and a first adjustment drive for pivoting the boom and a second adjustment drive for orienting the engine plate relative to the boom, the first adjustment drive comprises a monoaxial pivoting device comprising a first pivot axis, and the second adjustment drive comprises an at least biaxial pivoting device comprising a second and a third pivot axis, the second or the third pivot axis extending, or being positionable, in parallel with the first pivot axis.

### RELATED APPLICATION

This U.S. application claims foreign priority from Austrian patent application A 913/2014, filed Dec. 16, 2014, the complete disclosure of which is incorporated herein by reference.

### FIELD OF THE INVENTION

The invention relates to an adjustment mechanism for adjusting at least one engine of a spacecraft, including an engine plate for the at least one engine, a pivotable boom for pivoting the engine plate between a retracted position adjacent the spacecraft and at least one extracted position spaced apart from the spacecraft, and a first adjustment drive for pivoting the boom and a second adjustment drive for orienting the engine plate relative to the boom.

### BACKGROUND OF THE INVENTION

Electric engines of spacecraft, such as satellites, require adjustment mechanisms for adjusting the thrust vector. It is, for instance, frequently necessary for the thrust vector of the propulsion to extend through the center of gravity of the spacecraft in order to prevent the spacecraft from experiencing an angular momentum, which might lead to a spin. In this respect, it has to be taken into account that the center of gravity of the spacecraft will be subjected to changes with the fuel consumption increasing. However, special flight maneuvers also require the adjustment of a thrust vector that points past the center of gravity.

Adjustment devices for engines also serve to mechanically connect these components to the spacecraft with such stiffness that the take-off loads of a rocket take-off will be borne and disturbance torques during operation will not affect the orientation precision.

Adjustment mechanisms, as a rule, comprise at least one arm or boom, which is pivotally mounted about at least one pivot axis. The pivotal movement of the arm is accomplished by an adjustment motor. Said pivotal movement allows the engines to be held in a retracted position during take-off so as to be able to optimally take up the forces acting during take-off, and be extracted in the orbit so as to assume a maneuvering position. In doing so, the engines are to be in such positions during operation that their radiating elements will interfere as little as possible with the range of the solar panels of the spacecraft.

Conventional adjustment mechanisms with extensible booms comprise a first adjustment drive for pivoting the boom and a second adjustment drive for orienting the engine plate relative to the boom. Each adjustment drive comprises a pivot assembly, each with a single pivot axis such that an assembly of this type imposes considerable restrictions in terms of both the adjustment of the thrust vector and the selection of the adjustment path.

### SUMMARY

In general, a present adjustment mechanism, therefore, concerns a further developed adjustment drive to the effect that the above-identified restrictions associated with conventional devices will be avoided.

In the various aspects of the present adjustment mechanism, moreover, we aim to at least partially fulfill, e.g. satisfy, the following targets:

In the retracted state of the engine:
High stiffness and hence high natural frequency.
The number of fastening devices to the spacecraft required for achieving said high stiffness is to be minimized.
The engine plate is to be mounted in parallel with the satellite panel in order to enable a low-mass configuration during take-off, and to enable accessibility to the engines prior to take-off.
   During the extraction of the engine:
The volume swept during extraction is not to cover the travel range of the solar panel in order to exclude collisions.
The engines are to be positioned such that their radiating elements will interfere as little as possible with the range of the solar panels so as to prevent erosions of the solar panels.
The on-ground extraction of the engines under gravity for test purposes is to be possible by simple means, e.g. by compensating for the engine masses by guying using a rope.
   In the extracted state of the engine:
Configurations with a single engine and with several engines, e.g. a nominal engine and a redundant engine, are to be enabled.
In a central position, the propulsive jet of the engine is to point through the center of gravity of the spacecraft.
The propulsive jet of the engine is to be rotatable out of this central position so as to be able to point past the center of gravity on all sides.
Based on the ground plan of the spacecraft, the propulsive jet of the engine, moreover, is to be parallelly displaceable out of this central position.
The positions of the axes of rotation are to enable the operation of the satellite at low fuel consumption.

In accomplishing these and other advantages, we provide an adjustment mechanism for adjusting at least one engine of a spacecraft, including an engine plate for the at least one engine, comprising a pivotable boom for pivoting the engine plate between a retracted position adjacent the spacecraft and at least one extracted position spaced apart from the spacecraft, and a first adjustment drive for pivoting the boom and a second adjustment drive for orienting the engine plate relative to the boom, characterized in that the first adjustment drive comprises a monoaxial pivoting device comprising a first pivot axis, and the second adjustment drive comprises an at least biaxial pivoting device comprising a second and a third pivot axis, the second or the third pivot axis extending, or being positionable, in parallel with the first pivot axis.

In another of its aspects, an adjustment mechanism can be further characterized in that the first adjustment drive comprises a first rotation drive device arranged on the end of the boom facing the spacecraft for pivoting the boom about the first pivot axis, and the second adjustment drive comprises a second rotation drive device comprising the second pivot axis and a third rotation drive device comprising the third pivot axis, between the end of the boom facing away from the spacecraft and the engine plate.

In an additional aspect, an adjustment mechanism according to any embodiment herein can further characterized in that the second and the third pivot axes extend so as to be mutually inclined, in particular at a right angle.

In still another of its aspects, an adjustment mechanism according to any embodiment herein can be additionally characterized in that the length of the boom is larger than the distance between the second adjustment drive, in particular the second rotation drive device, and the engine plate.

Moreover, in another aspect, an adjustment mechanism according to any embodiment herein can also be additionally characterized in that the length of the boom corresponds to at least two times, in particular at least three times, in particular at least four times, the distance between the second adjustment drive, in particular the second rotation drive device, and the engine plate.

In a further one of its aspects, an adjustment mechanism according to any embodiment herein can be further characterized in that the rotation drive devices are comprised of electric motors.

Furthermore, in a yet further aspect, an adjustment mechanism according to any embodiment herein can also be characterized in that the engine plate comprises a fastening device which, in the retracted position of the engine plate, can be brought into operative connection with the spacecraft.

### BRIEF DESCRIPTION OF THE FIGURES

An adjustment mechanism for adjusting at least one engine of a spacecraft will be explained in more detail by way of exemplary embodiments schematically illustrated in the Figures.

FIG. 1 is a perspective view of an adjustment mechanism according to the invention in the retracted state.

FIGS. 2 and 3 depict an adjustment mechanism according to FIG. 1 in the extracted state, in a first and in a second adjustment position, respectively.

FIG. 4 is a schematic illustration of an alternative configuration of the adjustment mechanism in the retracted state.

FIG. 5 depicts the adjustment mechanism according to FIG. 4 in the extracted state.

### DETAILED DESCRIPTION

In one of its aspects, the invention provides that the first adjustment drive comprises an at least monoaxial pivoting device comprising a first pivot axis, and the second adjustment drive comprises an at least biaxial pivoting device comprising a second and a third pivot axis, the second or the third pivot axis extending, or being positionable, in parallel with the first pivot axis. The adjustment mechanism according to the invention thus comprises at least three pivot axes so as to enable an increase in the number of degrees of freedom. What is decisive here is that a pivot assembly with a pivot axis is provided as a pivot drive for the boom, and that a pivot assembly with at least two pivot axes is provided for orienting the engine plate relative to the boom. The first axis, which is provided for pivoting the boom relative to the spacecraft, is preferably disposed directly on the spacecraft, while the second and the third axes are spaced apart from the spacecraft by the boom and, in particular, disposed near the engine plate.

In that the second or the third pivot axis extends, or is positionable, in parallel with the first pivot axis, a parallel displacement of the engines can be performed in a simple manner. In this respect, it is irrelevant whether the second or the third pivot axis extends in parallel with the first pivot axis. The pivoting device comprising the second pivot axis is preferably arranged closer to the boom than the pivoting device comprising the third pivot axis. If the pivoting device comprising the second pivot axis is rigidly arranged on the boom, the second pivot axis will keep its position parallel to the first pivot axis irrespective of the respectively adjusted pivot angle of the other pivoting devices so as to enable parallel displacements of the engines in any state of the adjustment mechanism. Unless the second pivot axis extends in parallel with the first pivot axis, the invention contemplates that the third pivot axis has an extension parallel to the first pivot axis, or can be brought into said parallel position. The latter case will, in particular, be effected in that the pivoting device comprising the second pivot axis is brought into a pivot position in which the third pivot axis is in the required parallel position.

In the context of the present adjustment mechanism for adjusting at least one engine of a spacecraft, the biaxial pivotability of the engine plate relative to the boom allows for such a rotation as to enable the propulsive jet of the engine to point past the center of gravity on all sides. The configuration according to the invention, in particular, allows for the implementation of the following adjustment options: The engines can at first be positioned in a central position, in which the propulsive jet of the engine leads through the center of gravity of the spacecraft. Fine tuning of the central position can be performed by actuating the individual drive motors. From the central position, the engine can be rotated outwardly in such a manner as to be able to point past the center of gravity on all sides. Based on the ground plan of the spacecraft, the propulsive jet of the engine can, moreover, be parallelly displaced out of this central position by mutually operating the drive motors associated with the approximately parallelly arranged pivot axes.

The positions of the axes of rotation according to the invention allows for the operation of the spacecraft with low fuel consumption, since the engines can be brought into the optimum position for fuel-saving operation.

Furthermore, configurations both with one engine and with several engines, e.g. a nominal engine and a redundant engine, are readily feasible. Due to the parallel displaceability of the engine plate, which is provided by the arrangement of the axes, each of the engines can be moved into the optimum position, if required.

The axial arrangement according to the invention comprising a pivot axis for pivoting the boom results in that the pivotal movement can be configured such that the volume swept during extraction will not cover the travel range of a solar panel arranged in the vicinity of the engines so as to exclude collisions. The extraction movement is determined in a simple manner by the position of the first axis. If, as in correspondence with a preferred configuration, the first axis is arranged to be inclined relative to the side wall of the spacecraft, in particular satellite, the engines during extraction will move in the direction towards the lower side of the satellite rather than collide with the swept volume of the already extracted solar panels.

Besides, the engines can thus be brought into a position in which their radiating elements will radiate as little as possible into the region of the solar panels in order to prevent an erosion of the solar panels. The first pivot axis is preferably arranged such that the engines will be below the satellite after their extraction, so that the distance between radiating elements and solar panels will be maximized.

A preferred further development provides that the first adjustment drive comprises a first rotation drive device arranged on the end of the boom facing the spacecraft for pivoting the boom about the first pivot axis, and the second adjustment drive comprises a second rotation drive device comprising the second pivot axis and a third rotation drive device comprising the third pivot axis, between the end of the boom facing away from the spacecraft and the engine plate. The pivotability about each of the three axes is thus accomplished by a separate rotation drive device, hence ensuring a particularly sturdy structure and reliable mode of functioning. The rotation drive devices are advantageously comprised of electric motors.

In order to achieve the required biaxial pivotability by means of the second adjustment drive, it is preferably provided that the second and the third pivot axes extend so as to be mutually inclined, in particular at a right angle.

As already mentioned above, the first pivot axis is preferably arranged directly on the spacecraft, in particular satellite, and separated from the second and the third pivot axes by the boom. The pivoting device comprising the second pivot axis and the pivoting device comprising the third pivot axis are preferably arranged in the immediate vicinity to each other. In this context, a preferred further development of the invention provides that the length of the boom is larger than the distance between the second adjustment drive, in particular the second rotation drive device, and the engine plate. The length of the boom, in particular, corresponds to at least two times, in particular at least three times, in particular at least four times, the distance between the second adjustment drive, in particular the second rotation drive device, and the engine plate.

In order to fix the engine plate plus the at least one engine attached thereto during take-off, a preferred configuration provides that the engine plate comprises a fastening device which, in the retracted position of the engine plate, can be brought into operative connection with the spacecraft. The configuration is preferably devised such that the engine plate, in the retracted position, is oriented substantially in parallel with the side wall of the spacecraft, in particular satellite. This will result in a high stiffness, and hence high natural frequency, of the construction, since the engine plate can be rigidly connected to the wall of the satellite by standard fastening devices during the take-off phase of the satellite. The rotation drive devices are in this case also arranged close to the side wall of the satellite, or close to the engine plate, and hence likewise rigidly connected to the satellite structure. The only suspended part is the boom, which can be made light-weight. The boom is preferably configured as a framework structure.

The described configuration, moreover, results in that the number of fastening devices to the satellite necessary for achieving the high stiffness can be minimized. If the engine plate is oriented in parallel with the side wall of the satellite in the retracted state, it can be connected to the wall of the satellite during the take-off phase of the satellite by means of one or two standard fastening devices without requiring any separate fastening device for the adjustment drives.

The parallel arrangement of the engine plate relative to the satellite panel, moreover, enables a low-mass configuration during take-off, because no special support structures are required. Furthermore, the accessibility to the engines is thus enabled prior to take-off.

An exemplary adjustment mechanism for adjusting at least one engine of a spacecraft is now described with reference to the Figures.

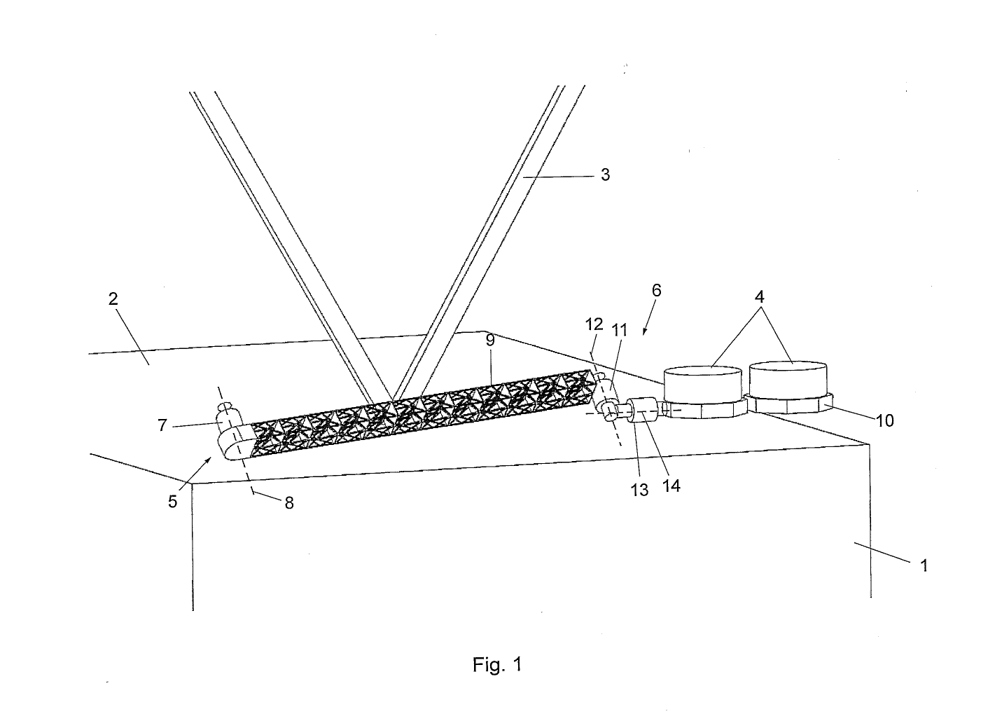

FIG. 1 schematically depicts a spacecraft, in particular satellite 1, whose outer shell is denoted by 2. To the satellite 1 are connected rotationally mounted mounting struts 3 for solar panels (not illustrated). Furthermore, two engines 4 adjacently arranged on an engine plate 10 are provided. An adjustment mechanism comprising a first adjustment drive 5 and a second adjustment drive 6 serves for the adjustment of the position and orientation of the engines 4. The first adjustment drive 5 comprises a rotation drive device 7, whose axis of rotation is denoted by 8. The rotation drive device 7 is fastened to the outer shell 2 of the satellite 1 in a manner not described in detail, and is connected to a boom 9. The rotation drive device 7 thus serves as a pivot drive for pivoting the boom 9 relative to the satellite 1 about the axis 8.

The boom 9 in this exemplary embodiment is configured as a framework structure comprising a plurality of rods. One end of the boom 9 is connected to the rotation drive device 7 and the other end of the boom 9 is connected to a rotation drive device 11 of the second adjustment drive 6. The rotation drive device is arranged such that its axis of rotation 12 extends in parallel with the axis of rotation 8 of the rotation drive device 7. The second adjustment drive further comprises a further rotation drive device 13, whose axis of rotation 14 extends transversely, in particular at a right angle, to the axis of rotation 12. The rotation drive device 12 serves to pivot the rotation drive device 13, which in turn serves to pivot the engine plate 10 fastened to it. A biaxial orientation of the engines 4 relative to the boom 9 will thus be ensured.

In the retracted state according to FIG. 1, the engine plate 10 is arranged in parallel with the side wall or outer shell 2 of the satellite 1. Departing from the retracted state, the described adjustment mechanism allows for the extraction of the boom 9 and almost any desired orientation of the engines. It is apparent that at no time of the extraction movement, the range of motion of the mounting struts 3 and the solar panels will be swept over.

By the counterclockwise operation of the rotation drive devices 7 and 11 comprising parallel axes 8 and 12, respectively, a parallel displacement of the engines 4 can, for instance, be effected. Operation about individual axes allows for an angular adjustment of the engines 4.

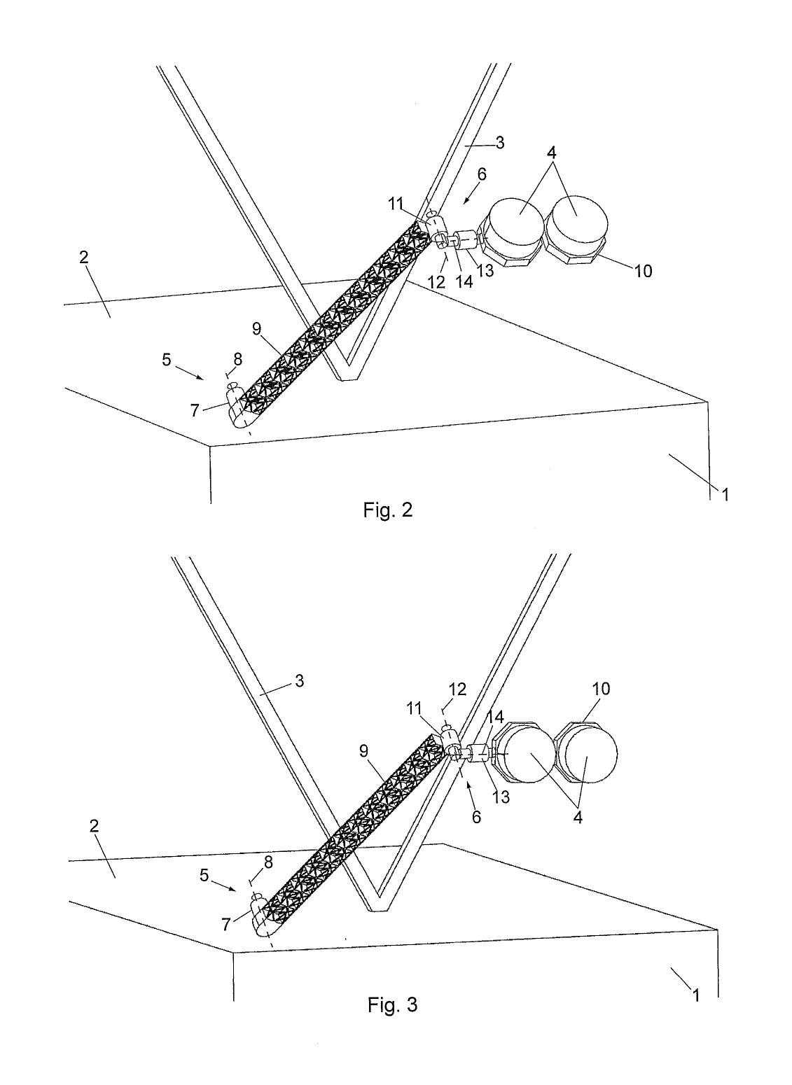

FIG. 2 depicts a first extracted position. Departing from the position illustrated in FIG. 2, the engine plate 10 can be tilted about the axis 14 by operating the rotation drive device 13 so as to achieve the orientation depicted in FIG. 3 of the engines 4.

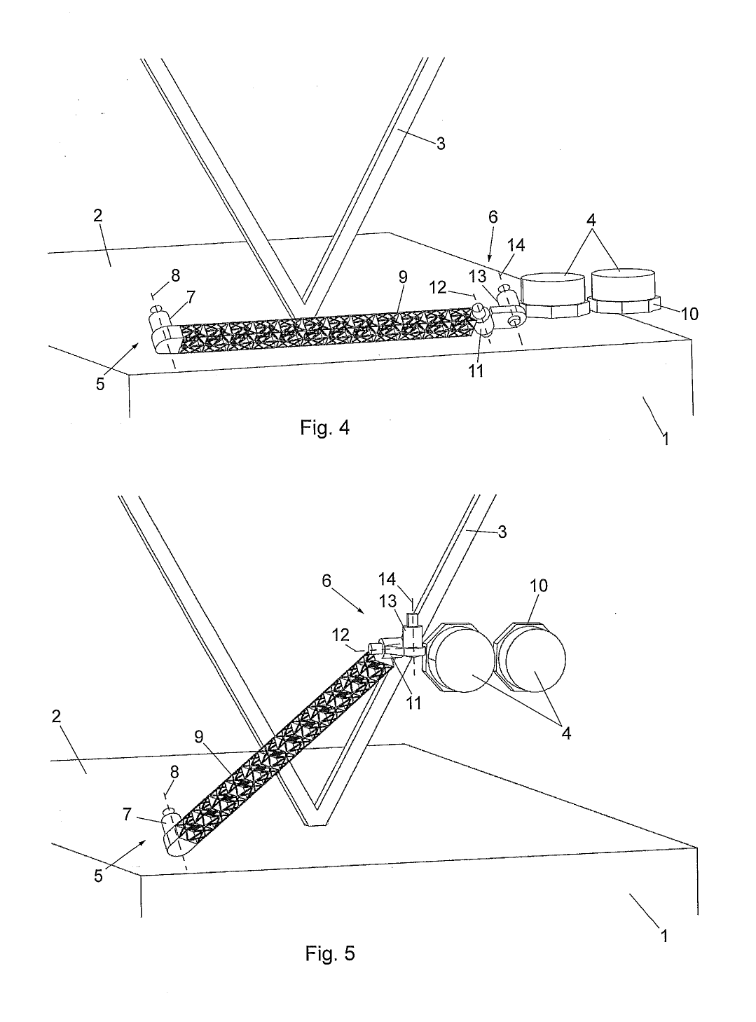

In FIG. 4, a modified configuration of the adjustment mechanism is shown, in which the axes of rotation of the rotation drive devices 11 and 13 are oriented differently from those in the configuration according to FIGS. 1 to 3. The axis of rotation 12 of the rotation drive device 11 extends not in parallel with, but transverse to, the axis of rotation 8, in particular at a right angle thereto. The axis of rotation 14 of the rotation drive device 13, in the position of the engine plate 10 depicted in FIG. 4, i.e. parallel with the side wall 2 or outer shell of the satellite 1, extends in parallel with the axis of rotation 8 of the rotation drive device 7. Departing from this starting position (position at take-off of the satellite 1) illustrated in FIG. 4, a parallel displacement of the engines 4 can again be effected by the counterclockwise operation of the rotation drive devices 7 and 13.

In FIG. 5, the engines are shown in the extracted position.

To sum up, our adjustment mechanism for space applications offers a number of advantages:
Low mass: due to the selected arrangement of the elements, no substantial support structures are necessary.
High reliability: due to the small number of release devices, the reliability is high.
Use of materials approved for spaceflight: The described extractable adjustment device can be made by standard materials used in spaceflight.
Low manufacturing costs: due to the selected arrangement of the elements, no substantial support structures are required and the number of components is small.
The production processes applied have to be controllable and testable: The extractable engine adjustment device described can be realized by standard manufacturing processes used in spaceflight.
The mechanical and electrical safeties must be verifiable by established calculation methods: The extractable engine adjustment device described can be verified using standard computation methods used in spaceflight.

We claim:

1. An adjustment mechanism for adjusting at least one engine of a spacecraft, including an engine plate for the at least one engine, a pivotable boom for pivoting the engine plate between a retracted position adjacent the spacecraft and at least one extracted position spaced apart from the spacecraft, and a first adjustment drive for pivoting the boom and a second adjustment drive for orienting the engine plate relative to the boom, characterized in that the first adjustment drive comprises a monoaxial pivoting device comprising a first pivot axis, and the second adjustment drive comprises an at least biaxial pivoting device comprising a second and a third pivot axis, the second or the third pivot axis extending, or being positionable, in parallel with the first pivot axis.

2. An adjustment mechanism according to claim 1, wherein the first adjustment drive comprises a first rotation drive device arranged on the end of the boom facing the spacecraft for pivoting the boom about the first pivot axis, and the second adjustment drive comprises a second rotation drive device comprising the second pivot axis and a third rotation drive device comprising the third pivot axis, between the end of the boom facing away from the spacecraft and the engine plate.

3. An adjustment mechanism according to claim 1, wherein the second and the third pivot axes extend so as to be mutually inclined, in particular at a right angle.

4. An adjustment mechanism according to claim 1, wherein the length of the boom is larger than the distance between the second adjustment drive, in particular the second rotation drive device, and the engine plate.

5. An adjustment mechanism according to claim 4, wherein the length of the boom corresponds to at least two times, in particular at least three times, in particular at least four times, the distance between the second adjustment drive, in particular the second rotation drive device, and the engine plate.

6. An adjustment mechanism according to claim 2, wherein the rotation drive devices comprise electric motors.

7. An adjustment mechanism according to claim 2, wherein the engine plate comprises a fastening device which, in the retracted position of the engine plate, can be brought into operative connection with the spacecraft.

8. An adjustment mechanism according to claim 1, wherein the first adjustment drive comprises a first rotation drive device arranged on the end of the boom facing the spacecraft for pivoting the boom about the first pivot axis, and the second adjustment drive comprises a second rotation drive device comprising the second pivot axis and a third rotation drive device comprising the third pivot axis, between the end of the boom facing away from the spacecraft and the engine plate; the second and the third pivot axes extend so as to be mutually inclined, in particular at a right angle; the length of the boom is larger than the distance between the second adjustment drive, in particular the second rotation drive device, and the engine plate; the rotation drive devices are comprised of electric motors; and the engine plate comprises a fastening device which, in the retracted position of the engine plate, can be brought into operative connection with the spacecraft.
